(19) United States
(12) Patent Application Publication
(10) Pub. No.: US 2025/0207423 A1
(43) Pub. Date: Jun. 26, 2025

(54) Underwater Pool Cleaning Robot with attached Solar Panel

(71) Applicant: Gabor Altdorfer, BELPRE, OH (US)

(72) Inventor: Gabor Altdorfer, BELPRE, OH (US)

(21) Appl. No.: 19/074,240

(22) Filed: Mar. 7, 2025

(51) Int. Cl. E04H 4/16; B63G 8/00; H02S 20/30

(52) U.S. Cl. CPC E04H 4/1654; B63G 8/001; B63G 2008/002; H02S 20/30

(57) ABSTRACT

Disclosed is an Underwater Pool Cleaning Robot (UPCR) with a submersible Solar Panel firmly attached to the housing of the UPCR providing solar charging for the On-Board Battery of the UPCR without external electric cables or connectors. In accordance with the disclosed configuration, any risk of electrocution hazard, current interruption problem, and tipping hazard can be avoided since no external cables and electric connectors are required or used.

### BACKGROUND OF THE INVENTION

### Field of the Invention

The present invention relates to the technical field of swimming pool cleaning by Underwater Pool Cleaning Robots (UPCR), and in particular, to UPCR powered by On-Board Batteries that are recharged by Solar Panels.

### Description of the Related Art

The function of the Underwater Pool Cleaning Robot (UPCR) is to vacuum, filter, and clean the pool water from submerged debris. The UPCR vacuums the bottom and the walls of the swimming pool by moving the pool water through its inlet opening then further through a filter element and then expels the cleaned water through its water outlet opening while trapping any debris in the filter element. The pool water is moved through the UPCR by an electric motor. The electric motor may be powered by electric cable or an on-board battery. The UPCR moves around the bottom and the walls of the swimming pool propelled by the force of the expelled water. The electric motor may not power the attached wheels which may move passively.

Conventional UPCR 200 (FIG. 7) may be connected 202 to a power supply 201 through a power cable 203 to receive their power or to recharge their on-board batteries from external electrical power supplies 201 that are located on the pool deck.

In other Conventional UPCR 300 (FIG. 8), a Solar Panel may be placed on a floating unit 303 that floats at the pool waterline and that may charge a battery housed inside the floating unit itself 303 that is electrically wired 302 and connected 301 to a UPCR 300 that is submerged, or the floating solar panel 303 may charge through an electric cable 302 and an electric connector 301 the battery that is housed inside such a UPCR 300.

The charging cables of conventional pool cleaning robots can be connected by standard waterproof electric connectors, contactless electromagnetic power supply connections, or wireless charging elements.

Such cables may present an electrocution hazard, they easily get entangled thus presenting a tipping hazard, and the power cable needs to be stored, so it is unsafe and very inconvenient to use a UPCR that requires cables.

### SUMMARY OF THE INVENTION

The invention concerns, first of all, an Underwater Pool Cleaning Robot (UPCR) to vacuum, filter and clean the swimming pool water from the submerged debris.

An object of the current invention is to provide a submersible solar panel that is firmly attached to the housing of the UPCR to supply electric charge power for the on-board battery of the UPCR.

A further object of the current invention is to provide a submersible solar panel firmly attached to the housing of the UPCR that does not need to be disconnected or removed while the UPCR is submerged.

A further object of the current invention is to eliminate all external electric cables and connectors between the solar panel and the on-board battery of the UPCR.

Still a further object of the current invention is to eliminate any risk of electrocution hazards, current interruption problems and tipping hazard, by eliminating any and all external cables and electric connectors.

According to the current invention, the Solar panel charges the on-board battery of the UPCR while the UPCR is on the pool deck. The solar panel may not provide charge while the UPCR is submerged.

According to the current invention, after solar charging of the on-board battery of the UPCR, the UPCR is submerged with the solar panel remaining attached, and then the UPCR vacuums, filters, and cleans the pool water by moving around underwater on the bottom and the sides of the pool.

The required power to the electric motor is provided by the on-board battery.

The electric motor rotates the motor shaft and the propeller thus moving the pool water through the UPCR housing and the filter element.

The force of the expelled water exiting from the UPCR moves the UPCR around on the bottom and the side of the pool, while the attached wheels may rotate passively and may not be powered by the electric motor.

### BRIEF DESCRIPTION OF THE DRAWING

Having thus described the disclosure in the foregoing general terms, reference will now be made to the accompanying drawings, which are not necessarily drawn to scale, and wherein:

FIG. 1 illustrates a frontal view of the UPCR according to the present invention;

FIG. 2A illustrates a frontal view of the UPCR according to the present invention;

FIG. 2B illustrates a corresponding section view of FIG. 2A of the UPCR;

FIG. 3 is a top view UPCR;

FIG. 4 is a bottom view UPCR;

FIG. 5 is a side view UPCR;

FIG. 6 is a back view UPCR;

FIG. 7 is an example of a Conventional UPCR system that may be connected to a power supply through a power cable;

FIG. 8 is another example of a Conventional UPCR that may be equipped with a Solar Panel on a floating unit that floats at the pool waterline and that may charge a battery on-board of the floating unit itself that is electrically wired to a UPCR that is submerged, or may charge a battery through an electric cable that is on-board the submerged UPCR.

### DETAILED DESCRIPTION OF THE PREFERRED EMBODIMENTS

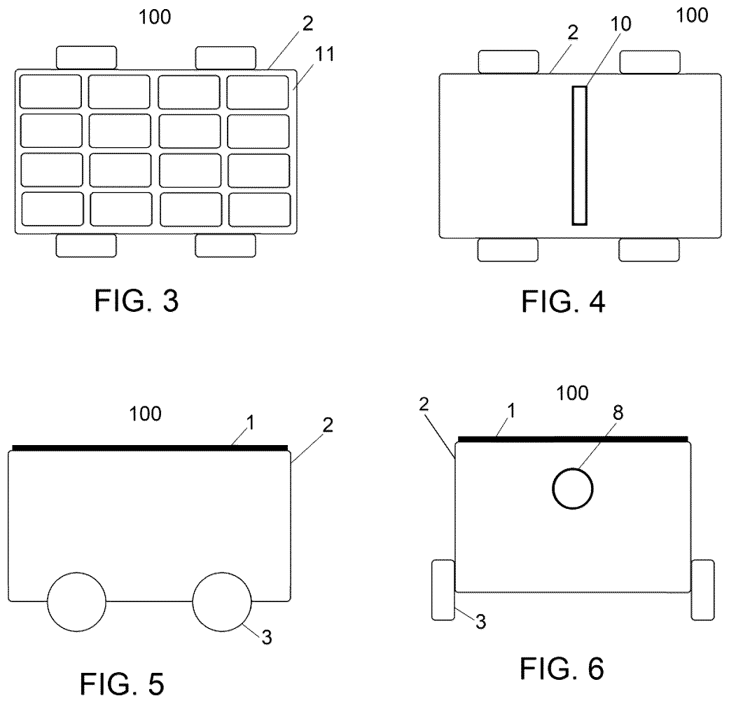

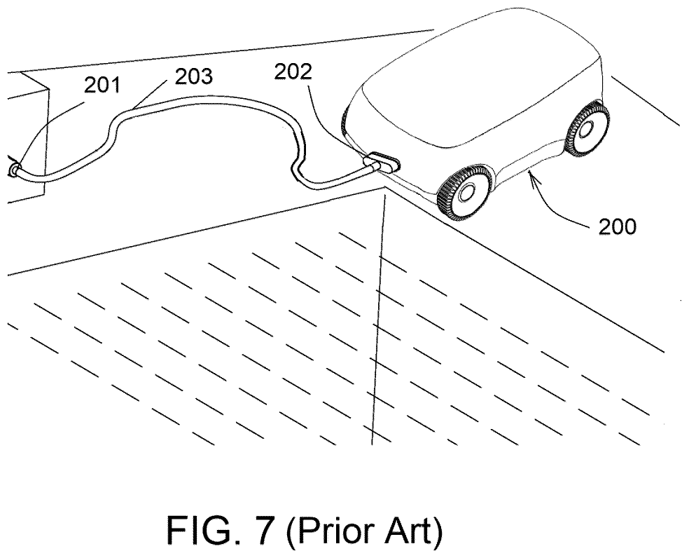

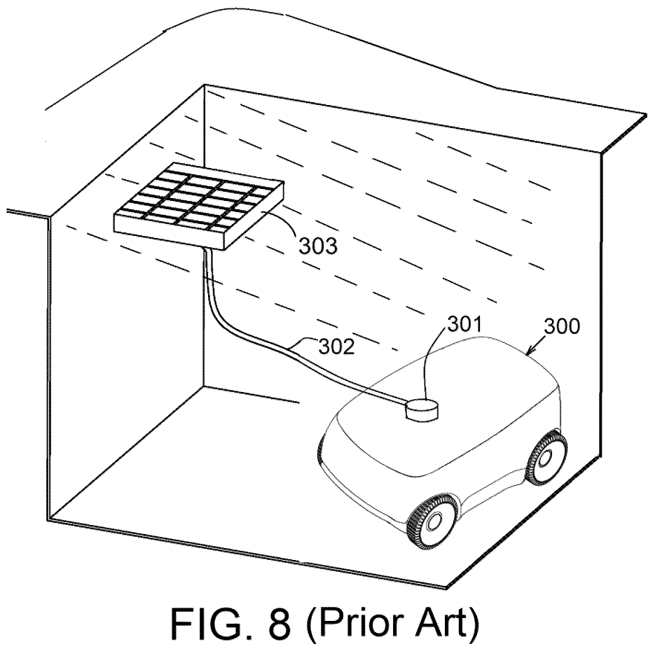

Referring now to FIGS. 1-6, the UPCR 100 in accordance with the present invention shown comprises at least one UPCR housing 2 with at least one attached solar panel 1, four attached wheels 3, and assembled inside the UPCR housing 2 comprises at least one filter element 9, one on-board battery 4, one electric motor 5, one propeller-shaft 6 and one propeller 7 assembled and enclosed thereby.

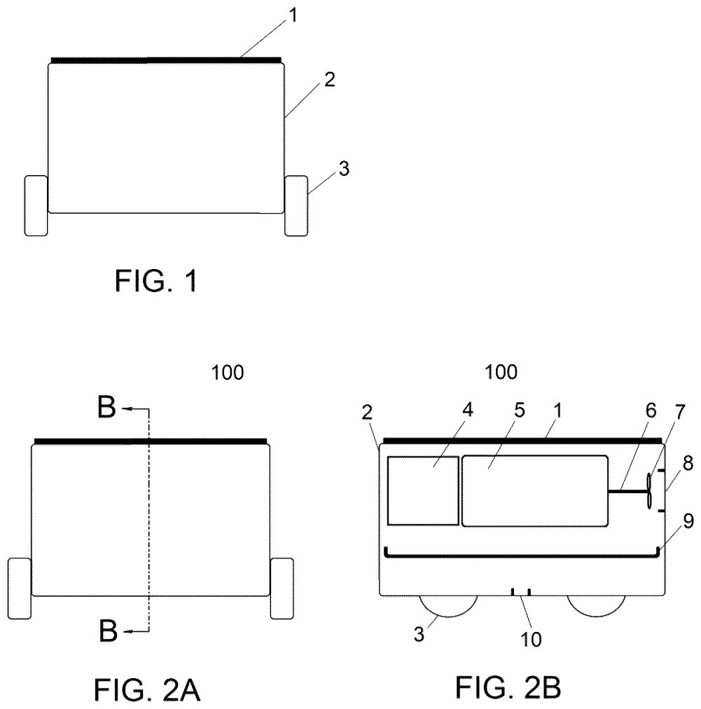

Referring further to FIGS. 2B, 4, and 6, the UPCR housing 2 has at least one water inlet opening 10 and at least one water outlet opening 8.

Referring further to FIGS. 2B, 4, and 6, an electric motor 5 rotates a propeller-shaft 6 and a propeller 7 to move the pool water first through a water inlet opening 10 then through a filter element 9, and finally through a water outlet opening 8 of the UPCR housing 2.

What is claimed is:

1. An Underwater Pool Cleaning Robot (UPCR) with a submersible Solar Panel firmly attached without external cables and connectors to the said UPCR
wherein,
the said UPCR is submerged in the pool water to vacuum, filter and clean the swimming pool water from the submerged debris.

2. The UPCR as claimed in claim 1, comprises at least one UPCR housing with at least one water inlet opening, one filter element, one water outlet opening, at least one attached solar panel, and four attached wheels.

3. The UPCR as claimed in claim 1, has assembled inside said UPCR housing comprising at least one filter element 9, one on-board battery 4, one electric motor 5, one propeller-shaft 6, and one propeller 7 assembled and enclosed thereby.

4. The UPCR is provided with a submersible solar panel firmly attached to the housing of the UPCR to supply electric charge power for the on-board battery of the UPCR.

5. The submersible solar panel is firmly attached to the housing of said UPCR in a non-removable manner.

6. The attached submersible solar panel does not need to be disconnected or removed while said UPCR is submerged.

7. The UPCR requires no external electric cables or connectors between the solar panel and the on-board battery of said UPCR.

8. By eliminating any and all external cables and electric connectors the claimed UPCR eliminates any risk of electrocution hazard, current interruption problems, and tipping hazard.

9. The Solar panel of the UPCR as claimed charges the on-board battery while the UPCR is on the pool deck, but the solar panel may not provide charge while the UPCR is submerged.

10. After solar charging the on-board battery of the UPCR in the pool deck, the UPCR is submerged while the solar panel remains attached.

11. The required power for the UPCR to move underwater is provided by an electric motor that is provided by the on-board battery of said UPCR.

12. The electric motor of said UPCR rotates the motor shaft and the propeller thus moving the pool water through the UPCR housing and the filter element.

13. The UPCR as claimed in claim 1, wherein the force of the expelled water exiting from the UPCR moves the UPCR around the bottom and side of the pool, while the attached wheels may rotate passively and not be powered by the electric motor.
